(19) United States
(12) Patent Application Publication
(10) Pub. No.: US 2025/0174643 A1
(43) Pub. Date: May 29, 2025

(54) NON-AQUEOUS ELECTROLYTE SECONDARY BATTERY AND METHOD FOR MANUFACTURING NEGATIVE ELECTRODE BINDER FOR NON-AQUEOUS ELECTROLYTE SECONDARY BATTERY

(71) Applicant: Panasonic Intellectual Property Management Co., Ltd., Osaka (JP)

(72) Inventors: KENTO CHIGUCHI, Osaka (JP); SHINICHI WAKI, Osaka (JP)

(21) Appl. No.: 18/841,358

(22) PCT Filed: Jan. 31, 2023
(86) PCT No.: PCT/JP2023/002949

§ 371 Date: Aug. 23, 2024

(30) Foreign Application Priority Data
Mar. 2, 2022 (JP) 2022-031610

(51) Int. Cl. H01M 4/485; H01M 4/02; H01M 4/1391; H01M 4/62

(52) U.S. Cl. CPC H01M 4/485; H01M 4/1391; H01M 4/62; H01M 2004/021; H01M 2004/027

(57) ABSTRACT

A disclosed non-aqueous electrolyte secondary battery includes a negative electrode. The negative electrode includes a negative electrode mixture containing a lithium titanium composite oxide as a negative electrode active material, an additive, and a boron compound which are mixed with one another. A disclosed method of manufacturing a negative electrode mixture for a non-aqueous electrolyte secondary battery includes a mixing step of mixing a lithium titanium composite oxide as a negative electrode active material, an additive, and a boron compound.

### TECHNICAL FIELD

The present disclosure relates to a non-aqueous electrolyte secondary battery and a method of manufacturing a negative electrode mixture for the non-aqueous electrolyte secondary battery.

### BACKGROUND ART

Various non-aqueous electrolyte secondary batteries have heretofore been proposed. PTL 1 (Japanese Patent No. 3969072) discloses a secondary battery which comprises, as its basic configuration, a negative electrode containing, as an active material, a lithium titanium oxide having a spinel structure indicated by a composition formula Li_{4/3}Ti_{5/3}O₄, a positive electrode containing, as an active material, a material that can insert and release lithium ions at voltage of 3V or higher (vs Li/Li⁺), and a non-aqueous electrolytic solution, characterized in that the non-aqueous electrolytic solution contains 0.1 to 10 weight % of propane sultone or 0.05 to 2.0 weight % of ethylene sulfite.

PTL 2 (International Publication No. 2018/110708) discloses a lithium titanate powder for an electrode of a power storage device. This lithium titanate powder is characterized by containing Li₄Ti₅O₁₂ as a main component, having a specific surface area of 4 m²/g or larger, and containing at least one localized element selected from a group consisting of boron (B), Ln (Ln is one metal element selected from the group consisting of La, Ce, Pr, Nd, Pm, Sm, Eu, Gd, Tb, Dy, Hb, Er, Tm, Yb, Lu, Y and Sc) and M1 (M1 is one metal element selected from the group consisting of W and Mo), wherein the localized element including at least one of boron (B), Ln and M1 exists in a state localized near the surface of each of lithium titanate particles constituting the lithium titanate powder.

### CITATION LIST

### Patent Literature

PTL 1: Japanese Patent No. 3969072
PTL 2: International Publication No. 2018/110708

### SUMMARY OF INVENTION

In recent years, the non-aqueous electrolyte secondary batteries have been used as power sources for monitoring air pressure of tires. In this use, the battery is sometimes exposed to an environment under a high temperature exceeding 100° C., and then is sometimes required to operate in a pulse discharge mode at a low temperature. Therefore, the non-aqueous electrolyte secondary batteries are required to maintain high quality battery characteristics even after having been exposed to a high temperature environment.

Under the above-described circumstances, an object of the present disclosure is to provide a non-aqueous electrolyte secondary battery that can maintain high quality battery characteristics even after the battery has been exposed to a high temperature environment.

A non-aqueous electrolyte secondary battery in an aspect of the present disclosure is a non-aqueous electrolyte secondary battery that includes a negative electrode, the negative electrode including a negative electrode mixture containing a lithium titanium composite oxide as a negative electrode active material, an additive, and a boron compound which are mixed with one another.

A method of manufacturing a negative electrode mixture for a non-aqueous electrolyte secondary battery in another aspect of the present disclosure includes a mixing step of mixing a lithium titanium composite oxide as a negative electrode active material, an additive, and a boron compound.

According to the present disclosure, it is possible to obtain a non-aqueous electrolyte secondary battery that can maintain high quality battery characteristics even after the battery has been exposed to a high temperature environment.

### BRIEF DESCRIPTION OF DRAWINGS

FIG. 1 is a longitudinal sectional view of a non-aqueous electrolyte secondary battery according to an exemplary embodiment of the present disclosure.

### DESCRIPTION OF EMBODIMENT

Although an exemplary embodiment of the present disclosure will hereinafter be described with examples, it should be noted that the present disclosure is not limited to the examples described below. Although specific numerical values and materials will sometimes be exemplified in the following description, other numerical values and materials may be applied as far as the invention according to the present disclosure can be practiced. In the present specification, the expression “numerical value A to numerical value B” includes numerical value A and numerical value B, and may be replaced with the expression “equal to or larger than numerical value A and equal to or smaller than numerical value B.” In a case where upper limits and lower limits of numerical values regarding a specific physical property or condition are exemplified in the following description, any of the exemplified lower limits may be combined with any of the exemplified upper limits as far as the selected lower limit does not exceeds the selected upper limit.

### Non-Aqueous Electrolyte Secondary Battery

A non-aqueous electrolyte secondary battery according to an exemplary embodiment will be described below. The non-aqueous electrolyte secondary battery may be referred to as “secondary battery(S)” in the following description.

The secondary battery(S) is a non-aqueous electrolyte secondary battery that includes a negative electrode. The negative electrode includes a negative electrode mixture containing a lithium titanium composite oxide as a negative electrode active material, an additive, and a boron compound which are mixed with one another.

A non-aqueous electrolyte used for the non-aqueous electrolyte secondary battery may be, for example, an electrolytic solution containing a non-aqueous solvent and a lithium salt dissolved in the non-aqueous solvent. Although the electrolytic solution is selected from materials each having an oxidation resistance and a reduction resistance, a part of the electrolytic solution may react with another material contained in the battery and decomposed to adversely affect the performances of the battery. For example, a reaction of an active material or an additive existing in the negative electrode with the electrolytic solution may reduce the quality of the battery characteristics. A battery placed particularly in a high temperature environment is largely affected by the decomposition of the electrolytic solution to largely reduce the quality of the battery characteristics.

As a result of studies and considerations, inventors of this application have newly discovered that high quality battery characteristics are maintained even after the battery has been exposed to a high temperature environment by mixing the boron compound with another component in the negative electrode mixture. The present disclosure is based on this newly discovered knowledge. It is not clear at present why the highly advantageous effect can be obtained by the above-described configuration. However, it is likely that the boron compound mixed with another component causes the boron compound to exist near the lithium titanium composite oxide and the additive in the negative electrode to thermodynamically suppress the decomposition of the electrolytic solution. It can be thought that the reactivity of the electrolytic solution to the boron compound is lower than the reactivity of the electrolytic solution to the lithium titanium composite oxide and the additive.

PTL 2 discloses a use, as the negative electrode active material, of a lithium titanate powder in which boron exists locally on surfaces of lithium titanate particles. In the negative electrode mixture of the secondary battery(S), on the other hand, not only the boron compound exists on the surface of the lithium titanium composite oxide, but also the boron compound is mixed with another component. This can be confirmed, for example, by an appropriate analysis.

In the negative electrode mixture, at least a part of the lithium titanium composite oxide may exist in a particulate form. In the negative electrode mixture, at least a part of the additive may exist in a particulate form. In the negative electrode mixture, at least a part of the boron compound may exist in a particulate form. Examples of particle shapes in the particulate forms include spherical shapes, flaky shapes, and rod shapes.

The boron compound may preferably be dispersed in the negative electrode mixture. The boron compound dispersed throughout the entire negative electrode mixture efficiently suppresses the reaction, with the electrolytic solution, of the lithium titanium composite oxide and the additive which are dispersed in the negative electrode mixture.

At least a part of the boron compound may exist on a surface of the additive (e.g., the surface of the particulate additive). This configuration adequately suppresses not only the reaction of the lithium titanium composite oxide with the electrolytic solution, but also the reaction of the additive with the electrolytic solution. Accordingly, it is effective to maintain the high-quality battery characteristics of the secondary battery(S).

The negative electrode active material is a material which reversibly absorbs and emits lithium ions. The lithium titanium composite oxide is an oxide which contains lithium and titanium. The lithium titanium composite oxide is high in the lithium ions acceptability. Further, the lithium titanium composite oxide per se does not have electrical conductivity, and has a high thermal stability. Accordingly, even in a case where an internal short-circuit in the battery is caused, a rapid flow of current will not occur, and also generation of heat will be suppressed.

The lithium titanium composite oxide may be a lithium titanate. The lithium titanate is preferable from the view point of its high resistance to high temperature. An example of the lithium titanate includes a lithium titanate having a spinel structure. A typical lithium titanate having a spinel structure is expressed by the composition formula Li₄Ti₅O₁₂. The lithium titanate having a spinel structure may preferably be used as the lithium titanium composite oxide. Accordingly, the term “lithium titanium composite oxide” listed in the following description may be replaced by the term “lithium titanate having a spinel structure.”

The negative electrode mixture of the secondary battery(S) contains an additive. Examples of the additive include a binder, a conductive agent, and other additives. The negative electrode mixture of the secondary battery(S) may contain an additive or may contain plural additives. The negative electrode mixture of the secondary battery(S) may contain at least one selected from the group consisting of a binder and a conductive agent. The additive may be a binder or may be a conductive agent or may contain both a binder and a conductive agent.

A material used as the binder may, for example, be a resin material. Examples of the resin material include: acrylic resins, such as polyacrylic acid, polymethacrylic acid, sodium polyacrylate, sodium polymethacrylate, and acrylic acid-ethylene copolymer; polyolefin resins; polyamide resins; polyimide resins; fluororesins, such as polyvinylidene fluoride (PVDF), polytetrafluoroethylene (PTFE), fluorinated-ethylene-propylene (FEP), and fluorovinylidene-hexafluoropropylene copolymer; and diene rubbers, such as styrene-butadiene copolymer (SBR), and ethylene propylene diene methylene linkage (EPDM). A single binder may be used, or two or more binders may be used in combination.

Examples of the conductive agent include carbon nanotubes (CNT), carbon fibers other than CNT, and electrically conductive particles (e.g., carbon black and graphites). A single conductive material may be used, or two or more conductive materials may be used in combination.

The amount of the boron compound contained in the negative electrode mixture may not be limited as far as advantageous effects of the present disclosure are obtained. Supposing MB be the number of moles of the boron atoms in the boron compound contained in the negative electrode mixture, and MC be the number of moles of the lithium titanium composite oxide contained in the negative electrode mixture, a ratio MB/MC may be 0.035 or larger, preferably 0.14 or larger, and 0.41 or smaller, preferably 0.28 or smaller. The ratio MB/MC may range from 0.035 to 0.41, preferably from 0.14 to 0.41. In these ranges, the upper limit may be changed to 0.28. The ratio MB/MC ranging from 0.035 to 0.41 enhances the battery characteristics much higher. The ratio MB/MC in the range from 0.35 to 0.28 (e.g., in the range from 0.14 to 0.28) enhances the battery characteristics particularly higher. In the lithium titanium composite oxide that is expressed by the composition formula Li₄Ti₅O₁₂, the number of moles of the lithium titanium composite oxide was calculated assuming the formula weight of Li₄Ti₅O₁₂ as the mass (g) of 1 mole.

Examples of the boron compound include boric acid (H₃BO₃) and boron oxide (B₂O₃). The negative electrode mixture may contain at least one selected from the group consisting of H₃BO₃ and B₂O₃. These boron compounds may suppress the reaction of the lithium titanium composite oxide with the electrolytic solution and the reaction of the additive with the electrolytic solution at the interface between the negative electrode mixture and the electrolytic solution.

### Method of Manufacturing Negative Electrode Mixture for Non-Aqueous Electrolyte Secondary Battery

A manufacturing method according to the present exemplary embodiment will be described below. This manufacturing method may hereinafter be referred to as “the manufacturing method (M).” The manufacturing method (M) is a method of manufacturing a negative electrode mixture for a non-aqueous electrolyte secondary battery. Since the matters described hereinabove in relation to the negative electrode mixture of the secondary battery(S) may be applied to the manufacturing method (M), duplicate description may be omitted. By the manufacturing method (M), the negative electrode mixture used for the negative electrode of the secondary battery(S) is manufactured. However, the negative electrode mixture for the secondary battery(S) may be manufactured by a method other than the manufacturing method (M).

The manufacturing method (M) includes a mixing step of preparing a lithium titanium composite oxide as a negative electrode active material, an additive, and a boron compound, and mixes the lithium titanium composite oxide, the additive, and the boron compound with one another. This mixing step provides a mixture in which the boron compound and another component mixed with one another. The mixture obtained in the mixing step may be used as the negative electrode mixture. By the manufacturing method (M), the negative electrode mixture of the secondary battery(S) is manufactured. The mixing method in the mixing step may not be limited, and may be any known method.

Materials usually mixed in the mixing step may be a particulate lithium titanium composite oxide, a particulate additive, and a boron compound. The boron compound may also be mixed in a particulate form. Examples of the particle shapes in the particulate form include spherical shapes, flaky shapes, and rod shapes.

In the mixing step, the above-described components may be mixed with a liquid component to obtain the mixture. Examples of the liquid component include water, alcohol (methanol, ethanol, etc.), and N-methylpyrrolidone.

The mixing step may include a first step of preparing a first mixture containing part of the components of the negative electrode mixture which are mixed with one another, and a second step of preparing a second mixture containing the other components of the negative electrode mixture mixed with the first mixture. As examples of the first and second steps, first to third examples will be described below.

A first example of the mixing step includes a step of mixing the additive with the boron compound to prepare the first mixture (the first mixing step), and a step of mixing the first mixture with the lithium titanium composite oxide to prepare the second mixture (the second mixing step). According to the first example of the mixing step, it is easy to dispose the boron compound on a surface of the additive (e.g., on surfaces of the particles of the additive).

A second example of the mixing step includes a step of mixing the lithium titanium composite oxide with the additive to prepare the first mixture (the first mixing step), and a step of mixing the first mixture with the boron compound to prepare the second mixture (the second mixing step). According to the second example of the mixing step, it is easy to uniformly distribute the boron compound on a surface of the lithium titanium composite oxide (e.g., on surfaces of the particles of the lithium titanium composite oxide) and on a surface of the additive (e.g., on surfaces of the particles of the additive) without an uneven distribution.

A third example of the mixing step includes a step of mixing the lithium titanium composite oxide with the boron compound to prepare the first mixture (the first mixing step), and a step of mixing the first mixture with the additive to prepare the second mixture (the second mixing step). According to the third example of the mixing step, it is easy to dispose the boron compound on a surface of the lithium titanium composite oxide (e.g., on surfaces of the particles of the lithium titanium composite oxide).

The components to be mixed in the first step and the second step and mixing ratios may be appropriately selected depending on the negative electrode mixture to be manufactured. The manufacturing method (M) may include the first example of the mixing step.

The components contained in the negative electrode mixture may be mixed in multiple steps. For example, in the first example of the mixing step, the conductive agent and the boron compound may be mixed with each other first, and then, the binder may be mixed to prepare the first mixture.

The manufacturing step (M) may include a step of preparing the materials to be mixed before the mixing step. Each of those materials may be a commercially available material. The particles of the lithium titanium composite oxide (the lithium titanium composite oxide powder) may be produced by a known method.

As described above, the lithium titanium composite oxide may be a lithium titanate. Also, as described above, the additive may contain at least one selected from the group consisting of a binder and a conductive agent.

The ratio of the components mixed in the mixing step is reflected on the ratio of the components in the negative electrode mixture to be manufactured. Accordingly, supposing Mb be the number of moles of the boron atoms in the boron compound mixed in the mixing step and Mc be the number of moles of the lithium titanium composite oxide mixed in the mixing step, the lithium titanium composite oxide and the boron compound may preferably be mixed in the mixing step such that the ratio Mb/Mc ranges exemplified with respect to the ratio MB/MC. For example, the lithium titanium composite oxide and the boron compound may be mixed in the mixing step such that the ratio Mb/Mc ranges from 0.035 to 0.41.

The boron compound may contain at least one selected from the group consisting of boric acid (H₃BO₃) and boron oxide (B₂O₃).

### Method of Producing Negative Electrode

The present specification discloses an example of the method of producing a negative electrode. This method of producing a negative electrode may not particularly be limited except that the method includes a step of producing a negative electrode mixture by the manufacturing method (M). The step of producing the negative electrode using the negative electrode mixture may not particularly be limited, and may be performed using any of known steps. For example, the negative electrode mixture may be pressed into a specific shape to form the negative electrode. As another method, a current collector may be coated with the negative electrode mixture to form a negative electrode including the current collector and a negative electrode mixture layer formed on the current collector. In this case, the negative electrode mixture formed on the current collector may be rolled and/or dried. In a case where a drying step is necessary during producing the negative electrode, the drying step may be carried out at a temperature equal to or higher than 100° C. and lower than 250° C., preferably equal to or lower than 200° C., such, for example, as in a range from 100° C. to 180° C. or in a range from 100° C. to 160° C. In other words, after the lithium titanium composite oxide and the boron compound have been mixed, the mixture is not exposed to a heat treatment at 250° C. or higher.

### Method of Producing Non-Aqueous Electrolyte Secondary Battery

The present specification discloses an example of the method of producing a non-aqueous electrolyte secondary battery. This method of producing the secondary battery may not particularly be limited except that the method includes the above-described method of producing a negative electrode. The method of producing the secondary battery using the negative electrode and other structural components may not particularly be limited, and may be performed using any of known steps. An example of such steps will be described below.

The structure of the secondary battery(S) may not particularly be limited as far as the advantageous effects of the present disclosure can be obtained. The shape of the secondary battery(S) may not particularly be limited, and may be either a prismatic shape or a coin shape. The type of the electrode group of the secondary battery(S) may not particularly be limited, and may be either a wound type or a laminated type. Example of the structural components of the secondary battery(S) will be described below. However, it should be noted that the structural components of the secondary battery(S) may not be limited to the examples described below.

The secondary battery(S) includes a positive electrode, a negative electrode, and a non-aqueous electrolyte. The secondary battery(S) further include a separator disposed between the positive electrode and the negative electrode. The electrode group including the positive electrode, the negative electrode, and the separator may be accommodated in an external body together with the non-aqueous electrolyte.

### Negative Electrode

The negative electrode includes a negative electrode mixture. The negative electrode mixture is usually used in a layered state (a negative electrode mixture layer). The negative electrode may include a negative electrode current collector, and a negative electrode mixture layer. In this case, the negative electrode mixture layer may be disposed on one or both of opposite surfaces of the negative electrode current collector.

The negative electrode current collector may be made of a sheet-form electrically conductive material, such as a metal foil, a mesh, a net, or a punching sheet. The negative electrode current collector may be made of, e.g., a stainless steel, nickel, a nickel alloy, copper, or a copper alloy. The thickness of the negative electrode current collector may not particularly be limited, and may range from 1 μm to 50 μm (e.g., from 5 μm to 30 μm).

The negative electrode mixture layer may be formed by, for example, dispersing the negative electrode mixture prepared in the above manner in a dispersing medium to obtain a negative electrode slurry, coating a surface of a negative electrode current collector with the negative electrode slurry, and drying the coated layer. The dispersing medium may not particularly be limited, and may, for example, be water, alcohol, N-methyl-2-pyrrolidone (NMP), or a mixed solvent of these. The coating layer after dried may be rolled as needed.

The thickness of the negative electrode mixture layer may not particularly be limited, and may be equal to or larger than 30 μm and equal to or smaller than 400 μm or may preferably be equal to or larger than 50 μm and equal to or smaller than 250 μm.

The average particle size of the particulate form lithium titanium composite oxide may range from 1.0 μm to 100 μm (e.g., from 1.0 μm to 40 μm). Here, the average particle size is a median diameter (D₅₀) at which the cumulative volume value becomes 50% in a volume-based particle size distribution. The volume-based particle size distribution may be measured by a commercially available laser diffraction particle-size distribution analyzer.

In the secondary battery(S), the negative electrode active material may contain other material in addition to the lithium titanium composite oxide. Examples of such other material include a material which electro-chemically absorbs and emits lithium ions, a lithium metal, and a lithium alloy. The material which electro-chemically absorbs and emits lithium ions may be a carbon material or an alloy material. However, the negative electrode active material is typically the lithium titanium composite oxide. The content percentage of the lithium titanium composite oxide in the negative electrode active material may be 90 mass % or more or preferably 95 mass % or more.

The content percentage of the lithium titanium composite oxide in the negative electrode mixture may range from 65 mass % to 98 mass % (e.g., from 85 mass % to 95 mass %). The content percentage of the binder in the negative electrode mixture may range from 0.5 mass % to 15 mass % (e.g., from 1.5 mass % to 10 mass %). The content percentage of the conductive agent in the negative electrode mixture may range from 0 mass % to 30 mass % (e.g., from 0 mass % to 25 mass %).

### Positive Electrode

The positive electrode includes a positive electrode mixture. The positive electrode may include a positive electrode current collector, and a positive electrode mixture layer. In this case, the positive electrode mixture layer may be disposed on one or both of opposite surfaces of the positive electrode current collector.

The positive electrode current collector may be a sheet-form electrically conductive material, such as a metal foil, a mesh, a net, or a punching sheet. Among these, the metal foil is preferably. The positive electrode current collector may be made of, e.g., a stainless steel, aluminum, an aluminum alloy, or titanium. The thickness of the positive electrode current collector may not particularly be limited, and may range from 1 μm to 50 μm (e.g., from 5 μm to 30 μm).

The positive electrode mixture may contain the positive electrode active material as an essential component, and may further contain a binder, a conductive agent, and other additive. The positive electrode mixture to be used may be any of the known positive electrode mixtures that are used for the lithium ion secondary batteries.

The positive electrode mixture layer may be formed by, for example, dispersing the positive electrode mixture in a dispersing medium to obtain a positive electrode slurry, coating a surface of a positive electrode current collector with the positive electrode slurry, and drying the coated layer. The dispersing medium may not particularly be limited, and may, for example, be water, alcohol, N-methyl-2-pyrrolidone (NMP), or a mixed solvent of these. The coating layer after dried may be rolled as needed.

The positive electrode active material reversibly absorbs and emits lithium ions. The positive electrode active material to be used may be a material functioning as a positive electrode active material when the above-described negative electrode active material is used. Examples of the positive electrode active material include lithium cobalt oxide (LiCoO₂), lithium nickel oxide (LiNiO₂), lithium iron phosphate (LiFePO₄), lithium-containing manganese oxides expressed by the general formula LiₓMnO_{y}, and lithium-containing transition metal oxides. From the view point of realizing a higher capacity, the lithium-containing transition metal oxide may be a lithium nickel oxide (a composite oxide N) that contains lithium and nickel and has a layered rock salt type crystal structure.

The composite oxide N may be an oxide expressed by the general formula Li_{α}Niₓ₁M1ₓ₂M2₍₁₋ₓ₁₋ₓ₂₎O_{2+β}. Here, element M1 is at least one selected from the group consisting of V, Co, and Mn. Element M2 is at least one selected from the group consisting of Mg, Al, Ca, Ti, Cu, Zn and Nb. The values of α, β, x1 and x2 may satisfy the conditions expressed as 0.9≤α≤1.1, −0.05≤β≤0.05, 0.5≤x1<1.0, 0≤x2≤0.5, and 0<1−x1−x2≤0.5. The value of a increases or decreases in response to charging or discharging. The composite oxide N may be a lithium nickel manganese cobalt oxide, such as LiNi_{1/3}Mn_{1/3}Co_{1/3}O₂ or LiNi_{0.8}Mn_{0.1}Co_{0.1}O₂.

The binder, the conductive agent and the other additive, which are used for the positive electrode mixture, may not particularly be limited. For example, the binder and the conductive agent may be used for the negative electrode mixture as described above.

### Non-Aqueous Electrolyte

The non-aqueous electrolyte that can be used may be a non-aqueous electrolyte having a lithium ion conductivity. The non-aqueous electrolyte may, for example, be an electrolytic solution that contains a non-aqueous solvent, and a lithium salt dissolved in the non-aqueous solvent. The concentration of the lithium salt in the electrolytic solution may be equal to or larger than 0.3 mol/L and equal to or smaller than 2 mol/L. The electrolytic solution may contain a known additive.

Materials that may be used as the non-aqueous solvent include, for example, cyclic carbonate esters, chain carbonate esters, and cyclic carboxylate esters. Examples of cyclic carbonate esters include propylene carbonate (PC), ethylene carbonate (EC), and fluoroethylene carbonate (FEC). Examples of chain carbonate esters include diethyl carbonate (DEC), ethyl methyl carbonate (EMC), and dimethyl carbonate (DMC). Examples of cyclic carboxylate esters include γ-butyrolactone (GBL), and γ-valerolactone (GVL). A non-aqueous solvent may be used independently or two or more non-aqueous solvents may be used in combination.

Examples of lithium salts include, for example, lithium salts of chlorine-containing acid (e.g., LiClO₄, LiAlCl₄, and LiB₁₀Cl₁₀), lithium salts of fluorine-containing acid (e.g., LiPF₆, LiBF₄, LiSbF₆, LiAsF₆, LiCF₃SO₃, and LiCF₃CO₂), lithium salts of fluorine-containing acid imide (e.g., LiN(SO₂F)₂, LiN(CF₃SO₂)₂, LiN(CF₃SO₂)(C₄F₉SO₂), and LiN(C₂F₅SO₂)₂), and lithium halides (e.g., LiCl, LiBr, and Lil). A single kind of lithium salt may be used independently or two or more kinds of lithium salts may be used in combination.

### Separator

The separator is disposed between the positive electrode and the negative electrode. The separator may have high ion permeability, and may have an appropriate mechanical strength and insulation properties. The separator may be, for example, a microporous membrane, a woven fabric, or a non-woven fabric. The material of the separator may be a polyolefin, such as polypropylene or polyethylene. The separator may have a heat-resistant insulating layer on at least one of its surface layers. The heat-resistant insulating layer may contain a non-organic oxide filler as a main constituent (by a content, for example, of 80 mass % or more) or may contain a heat-resistant resin as a main constituent (by a content, for example, of 40 mass % or more). The heat-resistant resin may, for example, be a polyamide resin, such as an aromatic polyamide (aramid), a polyimide resin, or a polyamide-imide resin.

### External Body

The external body of the secondary battery(S) may be selected depending on the shape or the like of the battery. The external body used may be selected from known external bodies. The external body may include, for example, a case, a gasket, and a sealing body.

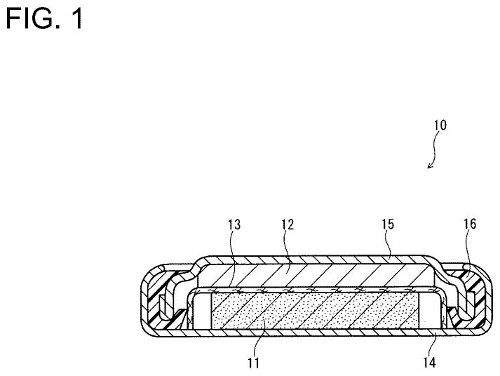

As an example of the secondary battery(S), a coin-type non-aqueous electrolyte secondary battery will be described with reference to FIG. 1. The secondary battery(S) is not limited to the exemplary embodiment described hereinafter.

FIG. 1 is a longitudinal sectional view of a coin-type non-aqueous electrolyte secondary battery 10. The coin-type non-aqueous electrolyte secondary battery 10 includes a positive electrode 11, a negative electrode 12, a separator 13 disposed between the positive electrode 11 and the negative electrode 12, and a non-aqueous electrolyte (not shown in the FIGURE). Each of the positive electrode 11, the negative electrode 12, and the separator 13 is contacts the non-aqueous electrolyte.

The positive electrode 11 includes the positive electrode mixture described above. One of opposite surfaces of the positive electrode 11 is electrically connected to a positive electrode case 14. The positive electrode case 14 accommodates therein the positive electrode 11 and the separator 13, and functions as a positive electrode current collector and a positive electrode terminal.

The negative electrode 12 includes the negative electrode mixture described above. One of opposite surfaces of the negative electrode 12 is electrically connected to a negative electrode case 15. The negative electrode case 15 contacts the negative electrode 12 and functions as a negative electrode current collector and a negative electrode terminal. The negative electrode case 15 further function as a sealing plate of the coin-type battery. The positive electrode case 14 and the negative electrode case 15 are insulated from each other with a gasket 16.

### EXAMPLES

The present disclosure will be specifically described based on examples below. However, the present disclosure is not limited to the following working example. In the examples, plural non-aqueous electrolyte secondary batteries which have different negative electrodes from one another were produced and evaluated.

### Producing Battery A1

Battery A1 as a coin-type non-aqueous electrolyte secondary battery was produced in the following steps.

### Producing Positive Electrode

Lithium cobalt oxide (LiCoO₂) (a positive electrode active material), acetylene black (a conductive agent), and polytetrafluoroethylene (a binder) were mixed with one another in a mass ratio of 90:5.0:5.0 to obtain a positive electrode mixture paste. The positive electrode mixture paste was dried to obtain a positive electrode mixture. A part about 100 mg in quantity of the positive electrode mixture was taken and press-molded at a pressure of 10 kN/cm² to obtain a pellet having a diameter of 10 mm. The obtained pellet was dried at 200° C. to obtain a positive electrode including a positive electrode mixture layer.

### Producing Negative Electrode

First, boric acid (H₃BO₃, a boron compound) and acetylene black (a conductive agent) were mixed with each other to obtain a mixture. Next, a powder of styrene butadiene latex (a binder) was dispersed in water and added to the mixture and mixed to obtain a first mixture. Next, a powder of lithium titanate (Li₄Ti₅O₁₂, a negative electrode active material) was mixed with the first mixture to obtain a negative electrode mixture paste (a second mixture). These materials were mixed in a mass ratio expressed as lithium titanate:acetylene black:styrene butadiene latex (a solid content):boric acid=90:5.0:4.6:0.4. In the negative electrode mixture paste, the above-described ratio Mb/Mc was 0.035. Accordingly, the above-described ratio MB/MC in the finally obtained negative electrode mixture may be regarded as 0.035. Here, the formula weight of Li₄Ti₅O₁₂ was made as the mass (g) of 1 mole of lithium titanate.

The negative electrode mixture paste was dried to obtain a negative electrode mixture. The obtained negative electrode mixture was press-molded at a pressure of 20 kN/cm² to obtain a pellet having a diameter of 10 mm. The obtained pellet was dried at 150° C. to obtain a negative electrode.

### Producing Coin-Type Battery

A coin-type non-aqueous electrolyte secondary battery having the same structure as the battery shown in FIG. 1 was produced with the above-described positive electrode and negative electrode. A non-woven fabric made of polypropylene was used as the separator. A 90 mg of electrolytic solution was injected into the case of the battery. The electrolytic solution was prepared by dissolving lithium tetrafluoroborate (LiBF₄) in γ-butyrolactone by a concentration of 1 mol/L.

### Batteries A2-A5

Batteries A2-A5 were produced in the same method as the above-described method of producing the battery A1 except that the conditions of producing the negative electrode mixture were changed. More specifically, the negative electrode mixtures of the batteries A2-A5 were produced in the same method as the above-described method of producing the negative electrode mixture of the battery A1 except for the boron compound and/or the values of the ratio MB/MC which were changed as shown in TABLE 1. The value of the ratio MB/MC was changed by changing the value of the ratio Mb/Mc. Here, the values of the ratio Mb/Mc were regarded as the values of the ratio MB/MC (the same is true for the battery C2 described below).

### Battery C1

Battery C1 was produced in the same method as the above-described method of producing the battery A1 except that the conditions of producing the negative electrode mixture was changed. More specifically, the negative electrode mixtures of the battery C1 was produced in the same method as the above-described method of producing the negative electrode mixture of the battery A1 except that the boron compound was not mixed in the negative electrode mixture paste.

### Battery C2

Deionized water was added to a powder of lithium titanate (Li₄Ti₅O₁₂) and stirred to prepare a slurry so that the concentration of the solid content became 30 mass %. Boric acid was added to the prepared slurry by 1.7 mass % with respect to the lithium titanate powder to prepare a mixed slurry. The ratio Mb/Mc was 0.13, where Mb denotes the mole number of boron atoms in the boric acid and Mc denotes the mole number of lithium titanate in the mixed slurry. The mixed slurry was dried by raising the temperature to 100° C. while being stirred to obtain a dried powder. The dried powder obtained was put in an alumina boat and heat-treated at 500° C. for one hour in a ring furnace. Through the steps as described above, particles of lithium titanate with boron localized on the surfaces of the particles were obtained.

Next, battery C2 was produced in the same method as the above-described method of producing the battery A1 except that the obtained powder of lithium titanate particles was used as the negative electrode active material.

### Low Temperature Pulse Voltage After High Temperature Storage

With respect to each of the produced batteries A1-A5, C1 and C2, the low temperature pulse voltage after the batteries had been stored in a high temperature condition was evaluated in the following manner.

The batteries were stored at 100° C. for 1000 hours in a thermostatic chamber, and then, the battery voltage of each battery was measured after a pulse discharge. More specifically, the batteries after having been stored in the high temperature condition were placed under an environment of −40° C., and the battery voltage (the low temperature voltage) of each battery was measured after performing a single pulse discharge (10 mA, 50 ms).

A part of the production conditions and evaluation results are shown in TABLE 1. In TABLE 1, a battery that is higher in the low temperature pulse voltage is higher in the battery characteristics.

TABLE 1

| | | | Low-Temperature |
|---|---|---|---|
| Battery | Boron Compound | MB/MC | Pulse Voltage [V] |
| A1 | H₃BO₃ | 0.035 | 0.931 |
| A2 | H₃BO₃ | 0.14 | 1.037 |
| A3 | H₃BO₃ | 0.28 | 0.967 |
| A4 | H₃BO₃ | 0.41 | 0.870 |
| A5 | H₃BO₃ | 0.15 | 1.015 |
| C1 | H₃BO₃ | 0 | 0.640 |
| C2 | H₃BO₃ (Used for | 0.13 | 0.678 |
| | Heat Treatment of | | |
| | Lithium Titanate) | | |

Battery C1 produced without mixing the boron compound in the negative electrode mixture and battery C2 containing boron locally disposed on surfaces of the lithium titanate particles are comparison examples. Differently from batteries C1 and C2, batteries A1-A5 containing the boron compound in the negative electrode mixture exhibited preferable battery characteristics even after having been stored in the high temperature condition. The reason for this may be considered that the negative electrode mixture not containing the boron compound suppresses not only the reaction of the lithium titanate with the electrolytic solution, but also the reaction of the additive with the electrolytic solution.

### INDUSTRIAL APPLICABILITY

The present disclosure is applicable to the non-aqueous electrolyte secondary batteries and the methods of manufacturing the negative electrode mixtures.

### REFERENCE MARKS IN THE DRAWINGS

10 non-aqueous electrolyte secondary battery
11 positive electrode
12 negative electrode
13 separator
14 positive electrode case
15 negative electrode case
16 gasket

1. A non-aqueous electrolyte secondary battery comprising a negative electrode, wherein
the negative electrode includes a negative electrode mixture containing a lithium titanium composite oxide as a negative electrode active material, an additive, and a boron compound which are mixed with one another.

2. The non-aqueous electrolyte secondary battery according to claim 1,
wherein at least a part of the boron compound exists on a surface of the additive.

3. The non-aqueous electrolyte secondary battery according to claim 1, wherein the lithium titanium composite oxide comprises a lithium titanate having a spinel structure.

4. The non-aqueous electrolyte secondary battery according to claim 1, wherein the additive contains at least one selected from the group consisting of a binder and a conductive agent.

5. The non-aqueous electrolyte secondary battery according to claim 1, wherein a ratio MB/MC ranges from 0.035 to 0.41, where MB is a number of moles of boron atoms in the boron compound contained in the negative electrode mixture, and MC is a number of moles of the lithium titanium composite oxide contained in the negative electrode mixture.

6. The non-aqueous electrolyte secondary battery according to claim 1, wherein the boron compound contains at least one selected from the group consisting of H₃BO₃ and B₂O₃.

7. A method of manufacturing a negative electrode mixture for a non-aqueous electrolyte secondary battery, the method comprising:
preparing a lithium titanium composite oxide as a negative electrode active material, an additive, and a boron compound; and
mixing the lithium titanium composite oxide, the additive, and the boron compound with one another.

8. The method according to claim 7, wherein said mixing comprises:
preparing a first mixture by mixing the additive and the boron compound with one another; and
preparing a second mixture by mixing the first mixture and the lithium titanium composite with one another after said preparing the first mixture.

9. The method according to claim 7, wherein the lithium titanium composite oxide comprises a lithium titanate having a spinel structure.

10. The method according to claim 7, wherein the additive contains at least one selected from the group consisting of a binder and a conductive agent.

11. The method according to claim 7, wherein said mixing comprises mixing the lithium titanium composite oxide and the boron compound together such that a ratio Mb/Mc ranges from 0.035 to 0.41, where Mb is a number of moles of boron atoms in the boron compound, and Mc is a number of moles of the lithium titanium composite oxide.

12. The method according to claim 7, wherein the boron compound contains at least one selected from the group consisting of H₃BO₃ and B₂O₃.
